(19) United States
(12) Patent Application Publication
(10) Pub. No.: US 2024/0398042 A1
(43) Pub. Date: Dec. 5, 2024

(54) Aerosol Generating Device Comprising a LED

(71) Applicant: JT International SA, Geneva (CH)

(72) Inventor: Akira Yamaguchi, Geneva (CH)

(73) Assignee: JT International SA, Geneva (CH)

(21) Appl. No.: 18/695,614

(22) PCT Filed: Oct. 7, 2022
(86) PCT No.: PCT/EP2022/077959

§ 371 Date: Mar. 26, 2024

(30) Foreign Application Priority Data
Oct. 8, 2021 (EP) 21201724.8

(51) Int. Cl. A24F 40/60; A24F 40/20; A24F 40/40; A24F 40/57; A24F 40/65; F21V 33/00; F21Y 115/10

(52) U.S. Cl. CPC A24F 40/60; A24F 40/20; A24F 40/40; A24F 40/57; A24F 40/65; F21V 33/0004; F21Y 2115/10

(57) ABSTRACT

An aerosol generating device is configured to operate with a consumable article defining an external surface and including a substrate part and a mouthpiece part. The device includes a housing, a cavity formed in the housing and configured to receive the substrate part of the consumable article, a heater arranged at least partially in the housing and configured to heat the substrate part, and an LED configured to be at one operational state during a vaping session and to emit light in this operational state, the LED being arranged on the housing so that the light emitted by the LED is reflected from the external surface of the consumable article when the LED is at the operational state.

### FIELD OF THE INVENTION

The present disclosure relates generally to an aerosol generating device, and more particularly to an aerosol generating device for heating an aerosol generating substrate to generate an aerosol for inhalation by a user. The present disclosure is particularly applicable to a portable (hand-held) aerosol generating device. Such devices may heat, rather than burn, an aerosol generating substrate by conduction, convection, and/or radiation, to generate an aerosol for inhalation.

### BACKGROUND OF THE INVENTION

The popularity and use of reduced-risk or modified-risk devices (also known as vaporizers or aerosol generating devices) has grown rapidly in recent years as an alternative to the use of traditional tobacco products. Various devices and systems are available that heat or warm aerosol generating substances to generate an aerosol for inhalation by a user.

One type of commonly available reduced-risk or modified-risk device is the heated substrate aerosol generating device, or so-called heat-not-burn device. Devices of this type generate an aerosol or vapour by heating an aerosol generating substrate to a temperature typically in the range 150° C. to 300° C. Heating the aerosol generating substrate to a temperature within this range, without burning or combusting the aerosol generating substrate, generates a vapour which typically cools and condenses to form an aerosol for inhalation by a user of the device.

Some devices of this type can operate with consumable articles, having for example an elongated shape which can be close to the shape of a conventional cigarette. Such consumable articles may comprise a substrate part and a mouthpiece part. The substrate part contains generally an aerosol generating substrate and is designed to be received inside the device to be heated by a heating system. The mouthpiece part can protrude from the device and is designed to cooperate with the user's lips and/or mouth.

The heating system is generally controlled by a controller which may for example chose a specific heating profile depending on user's preferences, article type, flavours, etc. However, for the user, it is not always possible to know the heating profile applied by the controller in a given vaping session. Additionally, it is not always possible to know whether the substrate part is heated or not, independently of the heating profile which may be used. To address this issue, some aerosol generating devices propose an indictor or even a screen to display this information. However, such an indictor or a display is generally arranged on an external surface of the device which affects its external design and ergonomic shape.

### SUMMARY OF THE INVENTION

One of the aims of the invention is to provide an aerosol generating device making it possible to indicate to the user at least one of its operational states, as for example a specific heating profile used by the heating system, without affecting the external design of the device and its ergonomic shape.

To this end, the present invention relates to an aerosol generating device configured to operate with a consumable article defining an external surface and comprising substrate part and a mouthpiece part;
the aerosol generating device comprising:
   a housing;
   a cavity formed in the housing and configured to receive the substrate part of the consumable article so as the mouthpiece part protrudes at least partially from the cavity;
   a heater arranged at least partially in the housing and configured to heat the substrate part of the consumable article;
   a LED configured to be at one operational state during a vaping session and emit light in this operational state, the LED being arranged on the housing so as the light emitted by the LED is reflected from the external surface of the consumable article when the LED is at said operational state.

Thanks to these features, the LED provided with the device can indicate when a particular heating profile is applied by the heater during the vaping session. Additionally, since the light emitted by the LED is reflected from the wrapper of the consumable article, the LED may be arranged in a location which does not affect the external design of the device or its ergonomic shape. Such a location can be invisible from the exterior of the device.

It is clear according to the invention that the light emitted by the LED is reflected from the external surface of the consumable article to be visible by the user. Thus, only the light reflected from the external surface of the consumable article is visible by the user. Any other part of the light emitted by the LED is invisible by the user.

According to some embodiments, the housing defines an insertion opening usable to insert the substrate part of the consumable article in the cavity, the LED being arranged adjacent to the insertion opening.

Thanks to these features, the light emitted by the LED can be visible by the user during for example a vaping session. Additionally, as it is arranged as far as possible from the user's mouth/lips during the vaping, the light does not disturb the user while vaping.

According to some embodiments, the LED extends at least partially around the insertion opening.

Thanks to these features, the light can be emitted homogeneously around the wrapper of the consumable article. Thus, a special visual effect can be achieved.

According to some embodiments, a sliding cover arranged on the housing and slidable between a closed position in which the insertion opening is closed and an open position in which the insertion opening is able to receive the consumable article;
the LED being arranged under the sliding cover.

According to some embodiments, the LED is arranged to be invisible from the exterior of the housing.

Thanks to these features, the LED can be invisible for the user in any operational state of the device.

According to some embodiments, the LED is arranged at a predetermined distance from said external surface of the consumable article, when the substrate part is received in the cavity.

Thanks to these features, the light emitted by the LED is not hidden by the consumable article when it is inserted in the device.

According to some embodiments, said distance is chosen based on a beam angle of the LED.

According to some embodiments, said distance is chosen:
substantially equal to 0.3 mm when the beam angle is comprised between 30° and 50°;
substantially equal to 0.5 mm when the beam angle is comprised between 20° and 40°;
between 0.8 mm and 1 mm when the beam angle is comprised between 10° and 30°.

Thanks to these features, it is possible to achieve a specific visual effect on the wrapper of the consumable article. Particularly, by varying the distance until the wrapper as well as the beam angle, it is possible to obtain different shapes/dimensions of the light's projection on the wrapper.

According to some embodiments, further comprising a controller configured to control:
the operation of the heater during a vaping session according to a heating profile chosen in a group of heating profiles comprising at least two different heating profiles;
the operational state of the LED depending on the heating profile used by the controller during said vaping session, said operational state being chosen in a group of operational states comprising at least two different operational states;

Thanks to these features, the LED can help the user to determine the heating profile used to operate the heater.

According to some embodiments, said group of heating profiles comprises a default heating profile and at least one customized heating profile.

Thanks to these features, the LED can help the user to determine whether a customized heating profile is used to operate the heater during the corresponding vaping session.

According to some embodiments, the or each customized heating profile is uploaded by a user to the controller, preferably using a wireless data connection.

According to some embodiments, the or each customized heating profile is chosen depending on the nature and/or on the flavour of a substrate contained in the substrate part.

Thanks to these features, the user can customizes the operation of the heater according to his/her own tastes. For example, the user can customize heating duration, temperature and/or frequency, to optimize his/her experience of vaping.

According to some embodiments, said group of operational states comprises:
no light emitting state;
an emitting state with a first light emitting characteristic.

according to some embodiments, the controller is configured to cause:
the no light emitting state of the LED when the default heating profile is used; and/or
the emitting state with a first light emitting characteristic of the LED when said customized heating profile is used.

Thanks to these features, the user can see the light only when a customized heating profile is used. When the heater is operated using the default heating profile, no light can be emitted and the user can thus understand that the device is used according to its default mode.

According to some embodiments said group of heating profiles comprises at least two different customized heating profiles.

According to some embodiments, said group of operational states further comprises an emitting state with a second light emitting characteristic.

According to some embodiments, the controller is further configured to cause the emitting state with the first light emitting characteristic or the emitting state with the second light emitting characteristic depending on the customized heating profile used during the vaping session.

Thanks to these features, in case of a plurality of customized heating profiles, the user can determine the customized heating profile being used during the vaping session. For example, the user can associate a particular colour to each customized heating profile and then, according to this colour, determine the customized heating profile being used.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is diagrammatic perspective view of an aerosol generating device according to the invention;

FIG. 2 is a diagrammatic cross-sectional view from a side of the aerosol generating device of FIG. 1, shown with a consumable article ready to be loaded into the aerosol generating device;
FIG. 3 is a diagrammatic perspective view of the aerosol generating device of FIG. 1, shown with the consumable article loaded into the aerosol generating device; and
FIG. 4 is a diagrammatic cross-sectional view from the side of the aerosol generating device of FIG. 1, shown with the consumable article loaded into the aerosol generating device.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

As used herein, the term “aerosol generating device” or “device” may include a vaping device to deliver an aerosol to a user, including an aerosol for vaping, by means of aerosol generating unit (e.g. an aerosol generating element which generates vapor which condenses into an aerosol before delivery to an outlet of the device at, for example, a mouthpiece, for inhalation by a user). The device may be portable. “Portable” may refer to the device being for use when held by a user. The device may be adapted to generate a variable amount of aerosol, e.g. by activating a heating system for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapor to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of precursor as one or more of: solid particles; liquid droplets; gas. Said suspension may be in a gas including air. Aerosol herein may generally refer to/include a vapor. Aerosol may include one or more components of the precursor.

As used herein, the term “vaporizable material” or “aerosol-forming precursor” may refer to one or more of a: liquid; solid; gel; mousse; foam or other substances. The vaporizable material may be processable by the heating system of the device to form an aerosol as defined herein. The vaporizable material may comprise one or more of: nicotine; caffeine or other active components. The active component may be carried with a carrier, which may be a liquid. The carrier may include propylene glycol or glycerin. A flavoring may also be present. The flavoring may include Ethylvanillin (vanilla), menthol, Isoamyl acetate (banana oil) or similar. A solid aerosol forming substance may be in the form of a rod, which contains processed tobacco material, a crimped sheet or oriented strips or shreds of reconstituted tobacco (RTB).

As used herein, the term “external device” may refer to a device, which is able to establish a wireless data connection with the aerosol generating device as it is explained in the specification. Such an external device may be a mobile device like a mobile phone for example. Additionally, such an external device may be a smart device able to process at least some data received from the aerosol generation device or intended to be transmitted to the aerosol generating device. Such a smart device can be a smartphone, a smartwatch, a tablet computer, a laptop, a desktop computer or any other smart object implemented for example according to the IoT (“Internet of things”) technology. Such a smart device can be also another aerosol generating device similar to said aerosol generating device. In some embodiments, the external device may be a distant server able to process data.

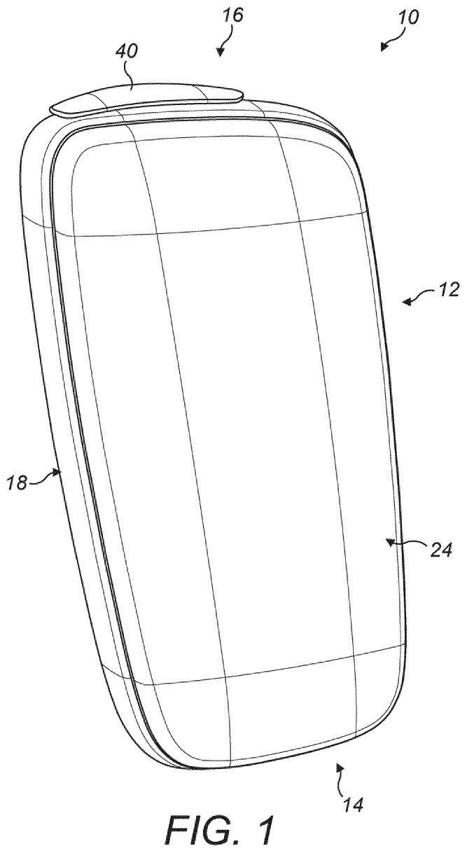

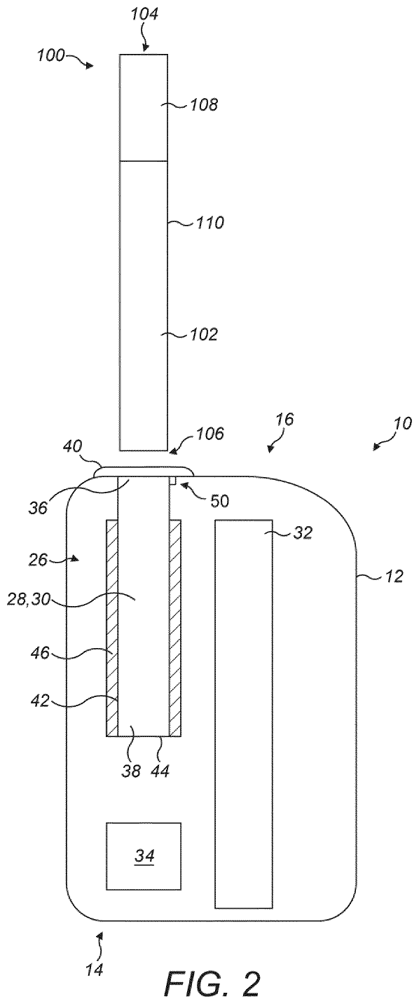

Referring to FIGS. 1 to 4, an aerosol generating device 10 comprises a housing 12 housing various internal components of the aerosol generating device 10. In the illustrated example, the housing 12 has an irregular shape, but it will be appreciated that any shape is possible, so long as it is sized to fit the components described in the various embodiments set out herein and to be comfortably held by a user unaided, in a single hand.

A first end 14 of the aerosol generating device 10, shown towards the bottom of each of FIGS. 1 to 4, is described for convenience as a distal, bottom, base or lower end of the aerosol generating device 10. A second end 16 of the aerosol generating device 10, shown towards the top of each of FIGS. 1 to 4, is described as a proximal, top or upper end of the aerosol generating device 10. During use, the user typically orients the aerosol generating device 10 with the first end 14 downward and/or in a distal position with respect to the user's mouth and the second end 16 upward and/or in a proximate position with respect to the user's mouth. In the example of the Figures, the housing 12 comprises a casing 18 and cover 24 removable from the casing 18 to allow access to at least some internal components of the aerosol generating device 10.

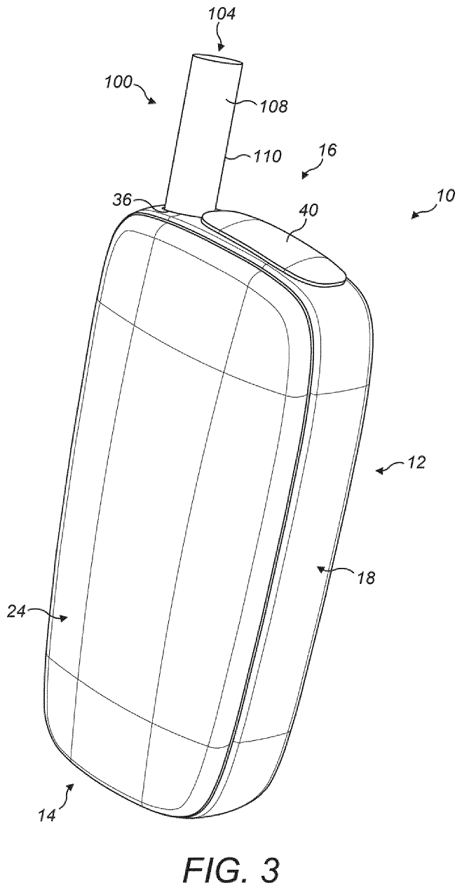

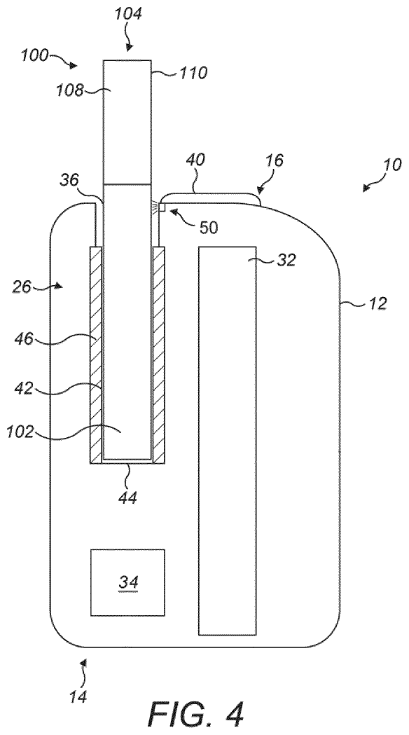

Referring to FIGS. 2 and 4, the internal components received by the housing 12 comprise notably an aerosol generating unit 26. The aerosol generating unit 26 comprises a heating chamber 28 defining a cavity 30 having a substantially cylindrical cross-section for receiving an consumable article 100, explained in further detail below. The aerosol generating unit 26 further comprises a power source 32, for example one or more batteries which may be rechargeable, and a controller 34. The aerosol generating unit 26 may comprise a chassis on which the heating chamber 28, the power source 32 and the controller 34 are mounted. At least some of these components may form a single unit.

The power source 32, also called more generally as battery, is received in a power source cavity extending along a longitudinal direction of the aerosol generating device 10.

The heating chamber 28 is open towards the second end 16 of the aerosol generating device 10. In other words, the heating chamber 28 has an open first end 36 towards the second end 16 of the aerosol generating device 10. In order to increase the thermal isolation of the heating chamber 28, the heating chamber 28 may be surrounded by insulation, for example a fibrous or foam material, such as cotton wool, aerogel or gas, or in other examples vacuum insulation may be provided.

The aerosol generating device 10 can further include a sliding cover 40 movable transversely between a closed position (FIGS. 1 and 2) in which it covers the open first end 36 of the heating chamber 28 to prevent access to the heating chamber 28 and an open position (see FIGS. 3 and 4) in which it exposes the open first end 36 of the heating chamber 28 to provide access to the heating chamber 28. The sliding cover 40 can be biased to the closed position in some embodiments.

The heating chamber 28, and specifically the cavity 30, is arranged to receive a correspondingly shaped generally cylindrical or rod-shaped consumable article 100 via an insertion opening formed by the open first end 36 of the heating chamber 28, as illustrated in FIGS. 2 to 4. Typically, the consumable article 100 comprises a substrate part 102 which contains a vaporizable material as defined above, advantageously in a solid form. The consumable article 100 has a proximal end 104 (or mouth end) and a distal end 106. The consumable article 100 further comprises a mouthpiece part 108 positioned downstream of the substrate part 102. The substrate part 102 and the mouthpiece part 108 are arranged in coaxial alignment inside a wrapper 110 (e.g., a paper wrapper) to hold the components in position to form the rod-shaped consumable article 100, as shown on the Figures.

The mouthpiece part 108 can comprise one or more of the following components (not shown in detail) arranged sequentially and in co-axial alignment in a downstream direction, in other words from the distal end 106 towards the proximal (mouth) end 104 of the consumable article 100: a cooling segment, a centre hole segment and a filter segment. The cooling segment typically comprises a hollow paper tube having a thickness which is greater than the thickness of the wrapper 110. The centre hole segment may comprise a cured mixture containing cellulose acetate fibres and a plasticizer, and functions to increase the strength of the mouthpiece part 108. The filter segment typically comprises cellulose acetate fibres and acts as a mouthpiece filter. As heated vapour flows from the substrate part 102 towards the proximal (mouth) end 104 of the consumable article 100, the vapour cools and condenses as it passes through the cooling segment and the centre hole segment to form an aerosol with suitable characteristics for inhalation by a user through the filter segment.

In other embodiments, the heating chamber 28 can be arranged to receive the substrate 102 in other forms, such as loose shredded material, solid material packaged in other ways, or as an aerosol generating liquid packaged in a consumable article 100.

Referring to FIGS. 2 and 4, the heating chamber 28 has a side wall 42 extending between a base 44 (located at a second end 38 of the heating chamber) and the open first end 36. The side wall 42 and the base 44 are connected to each another and can be integrally formed as a single piece. In the illustrated embodiment, the side wall 42 is tubular and, more specifically, cylindrical. However, in other embodiments the side wall 42 can have other suitable shapes, such as a tube with an elliptical or polygonal cross section. In yet further embodiments, the side wall 42 can be tapered.

In the illustrated embodiment, the base 44 of the heating chamber 28 is closed, e.g. sealed or air-tight. That is, the heating chamber 28 is cup-shaped. This can ensure that air drawn from the open first end 36 is prevented by the base 44 from flowing out of the second end 38 and is instead guided through the substrate part 102. It can also ensure that a user inserts the consumable article 100 into the heating chamber 28 an intended distance and no further.

The aerosol generating unit 26 includes a heater 46 for heating the substrate part 102 without burning it. In the illustrated embodiment, the heater 46 is a resistive heater which coextends with the side wall 42 of the heating chamber 28. Other types and configurations of the heater 46 can of course be used. For example, in some embodiments, the heater 46 can form a heating blade penetrating the substrate part 102 to heat it. According to some other embodiments, the heater 46 can form a magnetic coil able to magnetically interact with susceptors comprised in the substrate part 102. According to still other embodiments, notably in case of a liquid vaporizable material, the heater 46 may cooperate with a wicking system to evaporate the liquid.

In the illustrated embodiment, the heater 46 is mounted on a surface of the tubular side wall 42 facing away from an interior volume of the heating chamber 28. This can help to protect the heater 46 from damage as the consumable article 100 is inserted into the cavity 30 defined by the heating chamber 28.

The heater 46 of the aerosol generating unit 26, is electrically powered. That is, the heater 46 is arranged to heat the substrate part 102 using electrical power. For this purpose, the power source 32 is coupled to the controller 34. The controller 34 is in turn coupled to the heater 46. A user operates the aerosol generating device 10 using control means (not shown), arranged to cause coupling and uncoupling of the power source 32 to the heater 46 via the controller 34.

Particularly, the controller 34 is configured to control the operation of the heater 46 according to a heating profile chosen for each vaping session. According to different embodiments of the invention, the heating profile can determine at least one of the following elements, for example at least at some instants of the vaping session or over the whole vaping session:
temperature of the heater 46 or its surrounding region;
temperature of the substrate part 102 or its surrounding region;
power (for example voltage or electrical current) of the heater 46.

Additionally, the instants for which the heating profile is determined can correspond to different phases of the vaping session. For example, the vaping session can have a pre-heating phase and a heating phase. During the pre-heating phase, the heater 46 may be powered according to its maximal heating capacity to achieve rapidly a temperature of the substrate part 102 allowing vapour generating. During the heating phase, the heater 46 may be powered for example to keep a constant temperature of the substrate part 102.

Different heating profiles may thus lead to different styles of vaping. Additionally, a particular heating profile may also ensure a particular user experience (i.e. taste, flavouring, vapour quantity, vapour temperature, etc.) depending on the nature of the vaporizable material and/or at least some of its components.

According to the invention, the controller 34 is able to store a group of heating profiles comprising at least two different heating profiles. The group of heating profiles comprises at least one default heating profile. The default heating profile is for example a factory-determined profile which is suitable for most of the users and/or consumable articles. The group of heating profiles also comprises at least one customized heating profile which can for example be determined by the user. This customized heating profile may for example be determined using an external device (like a smartphone) and then, uploaded to the controller 34 using wireless data connection or any other type of connection. A customized heating profile may be thus determined according to the user's preferences or depending on the nature of the vaporizable material and/or at least some of its components.

According to the invention, the aerosol generating device 10 further comprises a LED 50 (for Light-Emitting Diode) arranged on the housing 12 and able to emit light which is reflected by an external surface of the consumable article 100 when the substrate part 102 is received in the cavity 30. In the example of the figures, the external surface of the consumable article 100 is formed by the wrapper 110. The LED 50 is for example arranged on an internal surface of the housing 12 to be invisible from the exterior of the housing 12. For example, the LED 50 can be arranged under the sliding cover 40, at least when the sliding cover 40 is in the open position.

As it is shown on FIGS. 2 and 4, the LED 50 may arranged adjacent to the insertion opening of the heating chamber 28, for example immediately under the wall forming the casing 18 or the cover 24. In some embodiments, the LED 50 is fixed to this wall. Additionally, the LED 50 is arranged at a predetermined distance from the wrapper 110, when the substrate part 102 is received in the cavity 30. For this purpose, the insertion opening may for example present greater transversal dimensions in comparison with the part of the heating chamber 28 adjacent to its second end 38. The predetermined distance until the wrapper 110 may for example be chosen based on a beam angle of the LED 50.

Particularly, by “beam angle”, it is understood the aperture of light cone formed by the LED 50 while emitting light, considering the LED 50 as a single light point. In case of several light points arranged for example along a predetermined direction, a “beam angle” is understood as the aperture of light cone formed in each cross-sectional plane perpendicular to said direction.

According to different embodiments of the invention, said distance until the wrapper 110 is chosen:
substantially equal to 0.3 mm when the beam angle is comprised between 30° and 50°;
substantially equal to 0.5 mm when the beam angle is comprised between 20° and 40°;
between 0.8 mm and 1 mm when the beam angle is comprised between 10° and 30°.

In the example of the Figures, the LED 50 is a single light point having for example a cuboid shape. For example, such a LED 50 may correspond to a known CL-195 Series LED or any other LED of similar model. According to other embodiments of the invention, the LED 50 may have any other suitable shape. For example, in one embodiment of the invention, the LED 50 has a circular shape extending at least partially around the insertion opening.

The LED 50 is electrically connected to the controller 34 so as the controller 34 is able to control its operation. Particularly, the LED 50 is configured to be at one operational state during a vaping session. This operational state is controlled by the controller 34 and defines at least one light emitting characteristic of the LED 50. The or each light emitting characteristic is chosen among: color of the light and visible frequency of light emitting (for example continuous light or blinking with a predetermined frequency).

Advantageously, according to the invention, the operational state of the LED 50 is chosen depending on the heating profile used by the controller 34 during said vaping session. For example, when the default heating profile is used by the controller 34, the LED 50 can be in no light emitting state which means that the LED 50 does not emit light at all during such a vaping session. When at least one customized heating profile is used by the controller 34, the LED 50 can emit light during the whole vaping session.

More generally, in case of a plurality of customized heating profiles, the controller 34 can associate to each customized heating profile a particular light emitting characteristic and define the operational state of the LED 50 corresponding to this light emitting characteristic. For example, the controller 34 can associate a particular color and/or light emitting frequency for each heating profile and define the operational state of the LED 50 corresponding to this color and/or light emitting frequency, depending on the heating profile chosen for the corresponding vaping session. According to another embodiment, a particular light emitting characteristic is chosen for each customized heating profile by the user, for example while uploading this profile to the controller 34. In this case, the association between each customized heating profile and the corresponding light emitting characteristic is memorized by the controller 34.

In order to use the aerosol generating device 10, a user displaces the sliding cover 40 from the closed position shown in FIGS. 1 and 2 to the open position shown in FIGS. 3 and 4. The user then inserts a consumable article 100 through the open first end 36 into the heating chamber 28, so that the substrate part 102 is received in the cavity 30 and so that the proximal end 104 of the consumable article 100 is positioned at the open first end 36 of the heating chamber 28, with at least part of the mouthpiece part 108 protruding from the open first end 36 to permit engagement by a user's lips.

Then, the user can activate the aerosol generating device 10 and notably the controller 34 and chose the heating profile for the current vaping session. For this purpose, the user can use appropriate control means or at least one button, like for example the ON/OFF button. For example, upon pushing once the ON button, the controller 34 can chose the default heating profile and cause the corresponding operational state (like for example no light emitting state) to the LED 50. Upon pushing twice the ON button, the controller 34 can chose a first customized heating profile and cause the cause the corresponding operational state (like for example a firs colour light emitting state) to the LED 50. A similar technique can be used to choose a second customized heating profile and so on. The user can for example switch off the device 10 upon pushing the ON button a predetermined number of times which is greater to the total number of the heating profiles memorized by the controller 34.

Upon choosing the heating profile, an electric current is supplied to the heater 46 causing it to heat up, according to this heating profile. The controller 34 causes the operational state of the LED 50 corresponding to the chosen heating profile. The light emitted by the LED 50 is reflected from the wrapper so as the user can determine the heating profile being used. The heat from the heater 46 is transferred through the side wall 42 of the heating chamber 28 to the adjacent substrate part 102 of the consumable article 100 positioned in the heating chamber 28, for example by conduction, radiation and convection. This results in heating of the substrate part 102 and a vapour is thereby generated. The generated vapour cools and condenses to form aerosol for inhalation by the user through the mouthpiece part 108, and more particularly through a filter segment. The vaporization of the substrate part 102 is facilitated by the addition of air from the surrounding environment through the open first end 36 of the heating chamber 28, the airflow being for example between the wrapper 110 and the inner surface of the cylindrical side wall 42.

1. An aerosol generating device configured to operate with a consumable article defining an external surface;
the aerosol generating device comprising:
a housing;
a cavity formed in the housing and configured to receive at least a part of the consumable article;
a heater arranged at least partially in the housing and configured to heat at least a part of the consumable article; and
an LED configured to be at one operational state during a vaping session and to emit light in the operational state, the LED being arranged on the housing so that the light emitted by the LED is reflected from the external surface of the consumable article to be visible by a user, when the LED is at said operational state.

2. The aerosol generating device according to claim 1, wherein the housing defines an insertion opening usable to insert at least a part of the consumable article in the cavity, the LED being arranged adjacent to the insertion opening.

3. The aerosol generating device according to claim 2, wherein the LED extends at least partially around the insertion opening.

4. The aerosol generating device according to claim 2, further comprising a sliding cover arranged on the housing (12) and slidable between a closed position in which the insertion opening is closed and an open position in which the insertion opening is able to receive the consumable article;
the LED being arranged under the sliding cover.

5. The aerosol generating device according to claim 1, wherein the LED is arranged to be invisible from an exterior of the housing.

6. The aerosol generating device according to claim 1, wherein the LED is arranged at a predetermined distance from said external surface of the consumable article, when at least a part of the consumable article is received in the cavity.

7. The aerosol generating device according to claim 6, wherein said distance is chosen based on a beam angle of the LED.

8. The aerosol generating device according to claim 7, wherein said distance is chosen:
substantially equal to 0.3 mm when the beam angle is between 30° and 50°;
substantially equal to 0.5 mm when the beam angle is between 20° and 40°;
between 0.8 mm and 1 mm when the beam angle is between 10° and 30°.

9. The aerosol generating device according to claim 1, further comprising a controller configured to control:
operation of the heater during a vaping session according to a heating profile chosen in a group of heating profiles comprising at least two different heating profiles;
the operational state of the LED depending on the heating profile used by the controller during said vaping session, said operational state being chosen in a group of operational states comprising at least two different operational states.

10. The aerosol generating device according to claim 9, wherein said group of heating profiles comprises a default heating profile and at least one customized heating profile.

11. The aerosol generating device according to claim 10, wherein the at least one customized heating profile is uploaded by a user to the controller.

12. The aerosol generating device according to claim 10, wherein the at least one customized heating profile is chosen depending on a nature and/or on a flavour of a substrate contained in the consumable article.

13. The aerosol generating device according to claim 10, wherein said group of operational states comprises:
no light emitting state; and
an emitting state with a first light emitting characteristic.

14. The aerosol generating device according to claim 13, wherein the controller is configured to cause:
the no light emitting state of the LED when the default heating profile is used; and/or
the emitting state with the first light emitting characteristic of the LED when said at least one customized heating profile is used.

15. The aerosol generating device according to claim 14, wherein:
said group of heating profiles comprises at least two different customized heating profiles;
said group of operational states further comprises an emitting state with a second light emitting characteristic; and
the controller is further configured to cause the emitting state with the first light emitting characteristic or the emitting state with the second light emitting characteristic depending on the customized heating profile used during the vaping session.

16. The aerosol generating device according to claim 10, wherein the at least one customized heating profile is uploaded by a user to the controller using a wireless data connection.
